(19) United States
(12) Patent Application Publication
(10) Pub. No.: US 2025/0254031 A1
(43) Pub. Date: Aug. 7, 2025

(54) Privacy-Preserving Decision Trees Using Secure Multiparty Computation and Differential Privacy

(71) Applicant: Oracle International Corporation, Redwood City, CA (US)

(72) Inventors: Arisa Tajima, Amherst, MA (US); Wei Jiang, Nolensville, TN (US); Virendra J. Marathe, Nashua, NH (US); Hamid Mozaffari, Seattle, WA (US)

(21) Appl. No.: 19/023,007

(22) Filed: Jan. 15, 2025

Related U.S. Application Data
(60) Provisional application No. 63/550,536, filed on Feb. 6, 2024.

(51) Int. Cl. H04L 9/08; G06F 16/22

(52) U.S. Cl. CPC H04L 9/085; G06F 16/2246; H04L 2209/46

(57) ABSTRACT

Privacy-preserving decision trees may be generated using secure multiparty computation and differential privacy. A decision tree generation protocol may determine class partitions and frequencies from a data set, determine a stopping condition is satisfied for determining the plurality of class partitions and the plurality of frequencies, determine a majority class for the data set, based on the plurality of class partitions and the frequencies, determine respective quality scores for the plurality of class partitions based on respective attributes for the plurality of class partitions, select an attribute of the respective attributes according to the respective quality scores, and partition the data set recursively to build a plurality of sub-trees according to an encoding determined for the selected attribute may be partitioned, in some embodiments.

### RELATED APPLICATIONS

Machine application claims benefit of priority to U.S. Provisional Application Ser. No. 63/550,536, entitled “Privacy-Preserving Decision Trees Using Secure Multiparty Computation and Differential Privacy,” filed Feb. 6, 2024, and which is incorporated herein by reference in its entirety.

### BACKGROUND

Machine learning models provide important decision making features for various applications across a wide variety of fields. Given their ubiquity, greater importance has been placed on understanding the implications of machine learning model design and training data set choices on machine learning model performance. Systems and techniques that can provide greater adoption of machine learning models are, therefore, highly desirable.

### SUMMARY

Techniques for privacy-preserving decision trees may be generated using secure multiparty computation and differential privacy are described. A decision tree generation protocol may determine class partitions and frequencies from a data set, determine a stopping condition is satisfied for determining the plurality of class partitions and the plurality of frequencies, determine a majority class for the data set, based on the plurality of class partitions and the frequencies, determine respective quality scores for the plurality of class partitions based on respective attributes for the plurality of class partitions, select an attribute of the respective attributes according to the respective quality scores, and partition the data set recursively to build a plurality of sub-trees according to an encoding determined for the selected attribute may be partitioned, in some embodiments.

### BRIEF DESCRIPTION OF THE DRAWINGS

FIG. 1 is a block diagram illustrating a system implementing privacy-preserving generation of decision trees, according to some embodiments.

FIG. 2 is a block diagram providing pseudocode illustrating a protocol for a recursive privacy-preserving technique for generating a decision tree, according to some embodiments.

FIG. 3 is a block diagram providing pseudocode illustrating a protocol for determining a score for an attribute, according to some embodiments.

FIG. 4 is a block diagram providing pseudocode illustrating a protocol for converting an index into a vector, according to some embodiments.

FIG. 5 is a block diagram illustrating a partial decision tree, according to some embodiments.

FIG. 6 is a block diagram providing pseudocode illustrating a protocol for making predictions using secret shares of a decision tree, according to some embodiments.

FIG. 7 is a block diagram providing pseudocode illustrating a recursive technique for generating a decision tree, according to some embodiments.

FIG. 8 is a block diagram providing pseudocode illustrating a recursive privacy-preserving technique for generating a decision tree, according to some embodiments.

FIG. 9 is a block diagram providing pseudocode illustrating a recursive privacy-preserving technique for generating a node of a decision tree, according to some embodiments.

FIG. 10 is a block diagram providing pseudocode illustrating a protocol for splitting a node of a decision tree, according to some embodiments.

FIG. 11 is a block diagram providing pseudocode illustrating a protocol for updating a leaf in a decision tree using a Laplace mechanism, according to some embodiments.

FIG. 12 is a block diagram providing pseudocode illustrating a protocol for updating a leaf in a decision tree using an exponential mechanism, according to some embodiments.

FIG. 13 is a block diagram providing pseudocode illustrating a protocol for integrating private encodings of attributes into a global domain, according to some embodiments.

FIG. 14 is a block diagram providing pseudocode illustrating a protocol for privacy-preserving noise generation using a Laplace mechanism, according to some embodiments.

FIG. 15 is a block diagram providing pseudocode illustrating a protocol for privacy-preserving noise generation using an exponential mechanism, according to some embodiments.

FIG. 16 is a high-level flowchart illustrating techniques to implement privacy-preserving decision trees using secure multiparty computation and differential privacy, according to some embodiments.

FIG. 17 is a block diagram illustrating one embodiment of a computing system that is configured to implement privacy-preserving decision trees using secure multiparty computation and differential privacy, according to some embodiments.

While the disclosure is described herein by way of example for several embodiments and illustrative drawings, those skilled in the art will recognize that the disclosure is not limited to embodiments or drawings described. It should be understood that the drawings and detailed description hereto are not intended to limit the disclosure to the particular form disclosed, but on the contrary, the disclosure is to cover all modifications, equivalents and alternatives falling within the spirit and scope as defined by the appended claims. Any headings used herein are for organizational purposes only and are not meant to limit the scope of the description or the claims. As used herein, the word “may” is used in a permissive sense (e.g., meaning having the potential to) rather than the mandatory sense (e.g. meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112(f) interpretation for that unit/circuit/component.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

### DETAILED DESCRIPTION OF EMBODIMENTS

Training machine learning (ML) models on distributed data while providing formal privacy guarantee regarding the training data brings a great value in various business settings. Without a privacy protection mechanism in place, data scientists may not be able to build any ML models. Suppose that data scientists want to build ML models on customer data from multiple organizations. Under the traditional and centralized technique, customer data need to be collected and managed by a central server. Data scientists interact with the server and perform the required computations to generate ML models. This centralized technique may not be always possible due to privacy risks and government regulations, such as the General Data Protection Regulation (GDPR).

To address potential privacy risks, privacy-enhancing technologies have emerged as promising techniques that can help data scientists analyze customers' data through the ML life-cycle without revealing private information in a distributed/federated environment. The common techniques include Federated Learning (FL), Homomorphic Encryption (HE), Secure Multiparty Computation (MPC) and Differential Privacy (DP), where each of these techniques has pros and cons. In FL, while data never leaves the data owners, the resulting model can be less accurate when compared to the centralized technique. Additionally, intermediate model parameters may leak information about each party's local training data. Recent works have studied secure training of decision trees under federated learning with HE and/or MPC. These techniques rely on cryptographic schemes and allow multiple parties to jointly train decision trees without revealing each party's private data. In addition, they can provide as good accuracy as the centralized technique. However, the output model may not necessarily be private and does not provide a formal DP guarantee. It is well known that models are vulnerable to membership inference attack. In other words, during inference, when models and/or prediction results are shared with data scientists or a third party, they can leak private information about individuals in the training data.

Independently, DP decision trees have extensively studied in the context of centralized learning where decision trees are learned over training data by answering queries under DP. A resulting model that satisfies DP can be publicly released for inference without degrading privacy loss. Because noise is introduced during a model training to satisfy DP, there is a cost of accuracy loss. The accuracy is mainly affected by the total privacy budget, the number of queries required to build decision trees, and the sensitivity of the queries. Since the server, which produces the DP-trees, has access to the original data, the scheme does not work in a federated environment where the participating parties do not want to disclose their private training data.

In order to protect the training data during both training and inference, a hybrid framework may be used that combines MPC and DP by training a centralized DP decision tree using MPC. However, the model accuracy provided by this approach is limited to what can be achieved by the centralized DP decision tree techniques. In addition, there may be no implementation and empirical evaluation of the unified framework of MPC and DP for decision tree training. Thus, the overhead of adding DP into MPC (or vice versa) during training is an open question. Furthermore, a synergy between MPC and DP is not well understood as the two techniques are often considered as orthogonal problems. In various embodiments, a way of combining MPC and DP that can provide a better accuracy than the existing approach under the same DP guarantee while offering data privacy and model confidentiality. Overall, the existing techniques do not satisfy one or more of the following properties:
Data privacy: Each party's private training data should not be disclosed to the other parties during model training and inference.
Model accuracy: The resulting model should be as accurate as possible.
Model confidentiality: This property is essential when the model has monetary value and disclosing the model may open the door for more effective inference attacks.
Query privacy: Query content and prediction result should be hidden from the servers that provide PPML services since query content may contain sensitive information.

A cloud-assisted setting may be considered where data scientists build tree-based models using cloud computing nodes for clients who own private data. Prediction results are shared with data scientists. One goal is to train a DP tree-based model as if the model were trained on a trusted server without participating parties sharing their private training data.

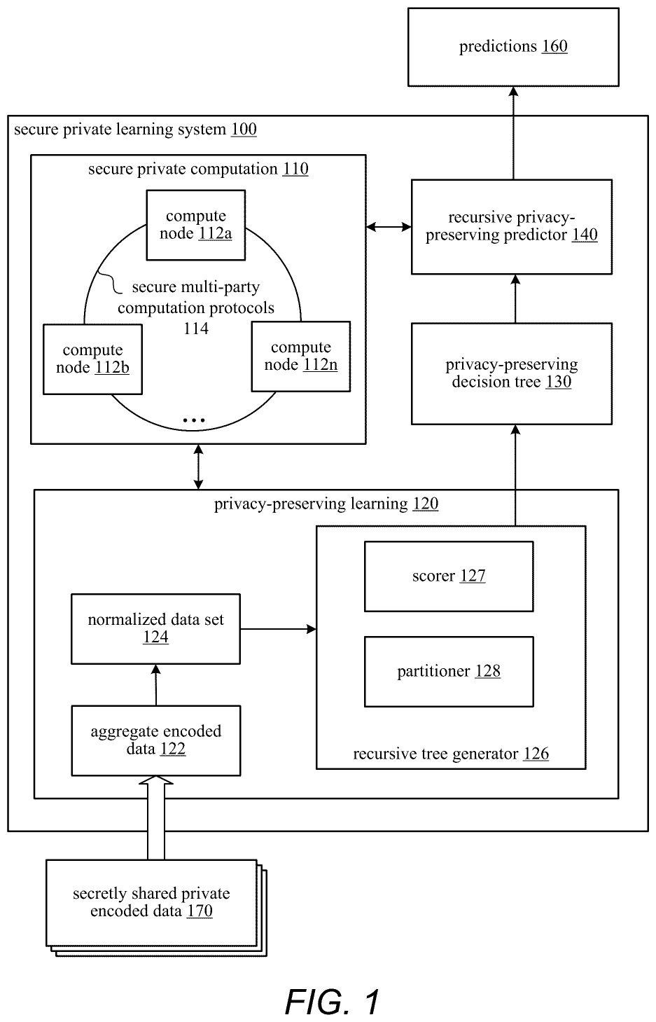

FIG. 1 is a block diagram illustrating a system implementing privacy-preserving generation of decision trees, according to some embodiments. In at least one embodiment, a secure private learning system 100 may learn from private data shared from multiple sources to generate a decision tree that may subsequently be used to make predictions 160.

To perform these tasks securely and privately, secure private learning system 100 may employ secure private computation 110. Secure private computation 110 may implement various privacy-preserving protocols to implement privacy-preserving learning 120 and a recursive privacy-preserving predictor 140. Collectively, these protocols may achieve properties defined previously. In order to maximize efficiency, a multi-server model may be utilized where data owners/clients secretly share private encoded training data 170 separate of three or more independent computing nodes or servers 112a, 112b . . . 112n. In at least one embodiment, model training is performed by the servers 112 using secret shares, and the learned model is also secretly shared and stored at the servers. In at least one embodiment, a user or data scientist may secretly shares its query with the servers who perform the required computation to derive a prediction 160 in secret share format. The shares are sent to the user who then reconstructs the actual prediction result. The following classes of entities may be considered:
Clients C: Each client Ci holds private training data and secretly shares its data with the cloud servers.
Servers S: The computing nodes or servers manage secretly shared data from the clients and collaboratively perform secure multi-party computation (MPC) protocols 114 to implement learning/training 120 and predicting 140. The servers also store the trained model and provide inference service to data scientists.
Users U: A user issues a query to the servers and receives shares of the prediction result. A user may be affiliated with a client or is authorized to the inference service.

Data Partitioning. In at least one embodiment, secure private learning system 100 may support data from multiple clients such as secretly shared private encoded data 170. When there are multiple data sources, data may be either horizontally or vertically partitioned during aggregation to generate aggregate encoded data 122.
Horizontal partition: the training data from each client have the same features but correspond to a disjoint-set of individuals.
Vertical partition: the training data from each client have a disjoint-set of features but correspond to the same individuals.

In at least one embodiment, a multi-server secure private computation 110 offers a high-level scalability especially when a multiple clients need to build an ML model on their aggregate data. Moreover, it works for either horizontal or vertical data partition scheme.

Threat Model. The semi-honest threat model may be considered where an adversary follows a privacy-preserving tree generation protocol but may try to infer the other parties' private information based on its own input, output and the messages received during protocol execution. The participating parties may not collude. Data privacy may be achieved from the perspective of each entity group:
Clients: Each client secretly shares its data with the servers and does not participate in any other computations related to model training and inference. Thus, it cannot learn any information about the other clients' training data.
Servers: They only perform computations on secretly shared data, and the original data are never reconstructed at the servers. In additional, any intermediate results, accessible to the servers, are either secretly shared or randomized. At a consequence, the servers cannot learn any information about the training data, except for certain domain knowledge, e.g., the domain size of each attribute and the number of attributes.
Users: A user receives secret shares of an inference result from the servers and reconstructs the actual result. Because the prediction result is differentially private, the user cannot learn anything about the training data more than what DP protects.

Adopting the multi-server setting, MPC protocols may be implemented for training tree-based machine learning (ML) models and their related inference tasks. The proposed protocols satisfy: data privacy, model accuracy, and model confidentiality, and query privacy. Various embodiments may work for any number of clients and users, but it requires at least three independent computing nodes or servers to perform secretly shared based MPC computations. The semi-honest adversary model may be considered in some embodiments, these techniques can extended to satisfy a malicious threat model. In summary, various embodiments have several significant contributions:
A way of combining MPC and differential privacy (DP) for tree based ML models that requires less amount of noise and with provable DP guarantee.
A formal security proof is provided to theoretically justify that the approach can achieve the same e-DP by only adding noise at the leaf level.
MPC protocols are implemented in a real distributed environment to generate extensive empirical data which are consistent with design intuition and theoretical analysis.

Differentially private decision trees have been well studied in the centralized setting, including decision trees, random forests and XGBoost. However, in the centralized setting, a party who builds a model is assumed to have access to the entire training dataset. Orthogonally, MPC-based decision tree training has been studied where a model is learned on secret-shared data and MPC-based protocols proposed for an ID3-based tree algorithm for cases of revealing and hiding the tree. Recent works have focused on a secure CART-based tree algorithm while keeping the model secret. While the training data are protected, those protocols do not provide DP guarantees and thus are susceptible to membership inference attacks.

Another usage is to train DP models in the federated setting to make them robust to membership inference attacks, which align with a motivation. Maddock et al. provided a general framework of learning DP gradient boosted decision tree models in a federated setting. Their framework uses secure aggregation-based MPC and DP. However, since the majority operations are performed locally at each party, techniques that require centralized evaluation such as the Exponential mechanism was not considered. This can be a limitation since many DP decision tree-based algorithms require the Exponential mechanism to provide a good accuracy. The framework relies on a secret-sharing scheme and thus can completely simulate a centralized DP learning in a federated setting. Wu et al. briefly introduced how to train a centralized DP decision tree with an MPC framework in a federated setting. Their approach of combining MPC and DP during tree generation process is very different from ours that only adds noise at the leave level and produces more accurate results, and it only works for vertically partitioned situation. Furthermore, they do not have an implementation and empirical evaluation of the hybrid framework of MPC and DP and thus efficiency of the framework was not clear.

Another essential and often overlooked aspect is that when analyzing DP guarantee, the existing work on DP-tree models neglects the fact that the tree structure itself can reveal information about the training data, and their DP analyses ignore the impact of the tree structure. Therefore, the existing techniques may not achieve the expected DP guarantee. Existing techniques do not appear to comprehensively analyze the connection between MPC and DP for decision trees from the perspective of privacy, accuracy and efficiency. This is because MPC and DP are often considered orthogonal problems. However, it may be shown that the existing way of combining MPC and DP can result in sub-optimal performance. In addition, by taking advantage of the inherent privacy guarantee of an MPC protocol, that adding noise to the leaf nodes (or less noise overall) is sufficient to achieve the same level of DP while simultaneously improving accuracy comparing to the existing approaches.

One goal is to completely hide all intermediate information about the data, keeping the tree secret. Importantly, every non-leaf node must have the same number of branches.

This can be achieved by adding dummy values to each attribute so that every attribute has the same domain size of w=maxᵢ|dom(Aᵢ)|. A complete w-ary tree may be built except for leaf nodes with |dom(C)| labels. Also, the stopping criterion only checks if the tree reaches the maximum depth.

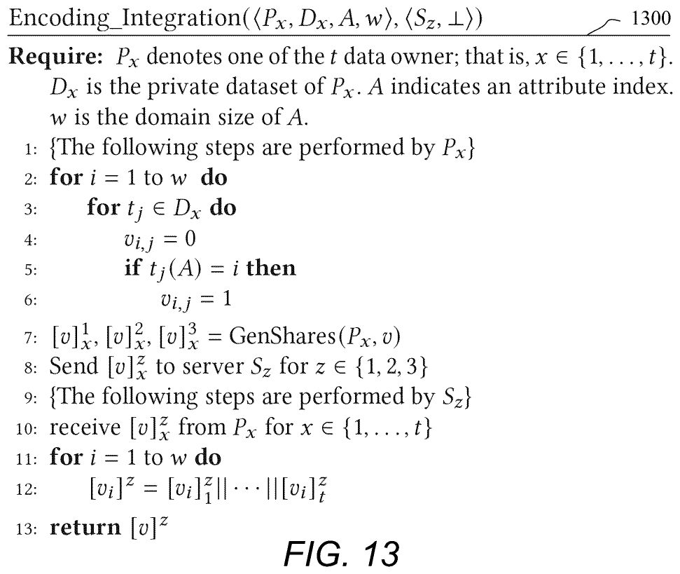

Before executing the model generation protocol, each data owner needs to locally pre-process its data. Data owners may apply consistent pre-processing strategies, such as discretization, handling missing values, etc. In addition, data integration at the servers can be tricky. Under the vertical partition scheme, the data owners generate one-hot encodings for their attributes and then secretly share the private encodings 170 with the computing servers. The servers need to store the shares in the same ordering which can be guaranteed easily even if they do not know the data schema and attribute domains. Under horizontal partition, it becomes more challenging to integrate the shares depending whether or not the schema is known. This issue is discussed below in FIG. 13.

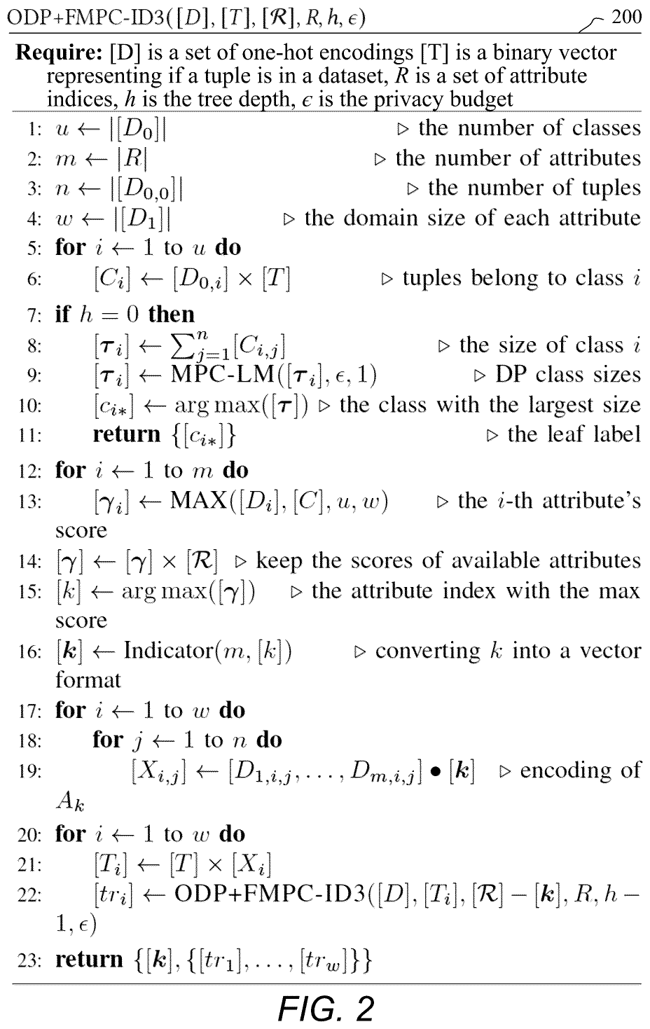

In at least one embodiment, the servers first securely aggregate the shared encoded data 122 and then add dummy values to each attribute as needed so that every attribute has the same domain size to generate a normalized training data set 124. This data set is the input to a recursive tree generator 126 that includes a scorer 127 and partitioner 128. The recursive tree generator 126 then recursively and securely generates various tiers or levels of a decision tree, terminating with a leaf tier. All leaves of the decision tree reside at a same level as assured by the normalized data 124. Upon completion, the recursive tree generator 126 may securely generate a privacy-preserving decision tree 130. The various MPC protocols are discussed in further detail below in FIGS. 2-16.

FIG. 2 is a block diagram providing pseudocode illustrating a protocol for a recursive privacy-preserving technique for generating a decision tree, according to some embodiments. In the Tree Generation Protocol 200, the following notation conventions may be used:
[x]: secret shares of x, and where bold lower case letter to represent a vector: [xᵢ] represents the shares of its i-th component of vector x. Capital letter may be used to represent a multi-dimensional data or a vector.
D: the dataset represented as a set of one-hot encodings. D is three-dimensional:
D_{i,j,k} represents the k-th component of the j-th one-hot encoding of the i-th attribute. In other words, Dᵢ is matrix and a collection of encodings for attribute At.
T: a binary vector representing if a tuple is in a data set.
R: a set of attribute indices (excluding class attribute index 0) and R a binary vector of size |R| indicating the available attributes for the current recursive call.
h: the tree high bounded by 1≤h≤| [symbol] −{A₀}|.
[x]·[y]: represent a secure dot product between two secretly shared vectors.
[x]×[y]: represent secure component-wise multiplications between two secretly shared vectors.

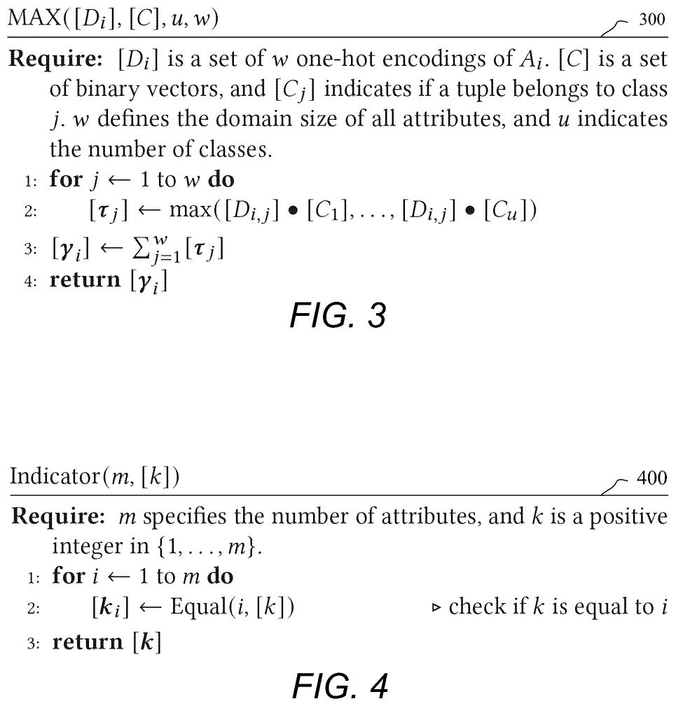

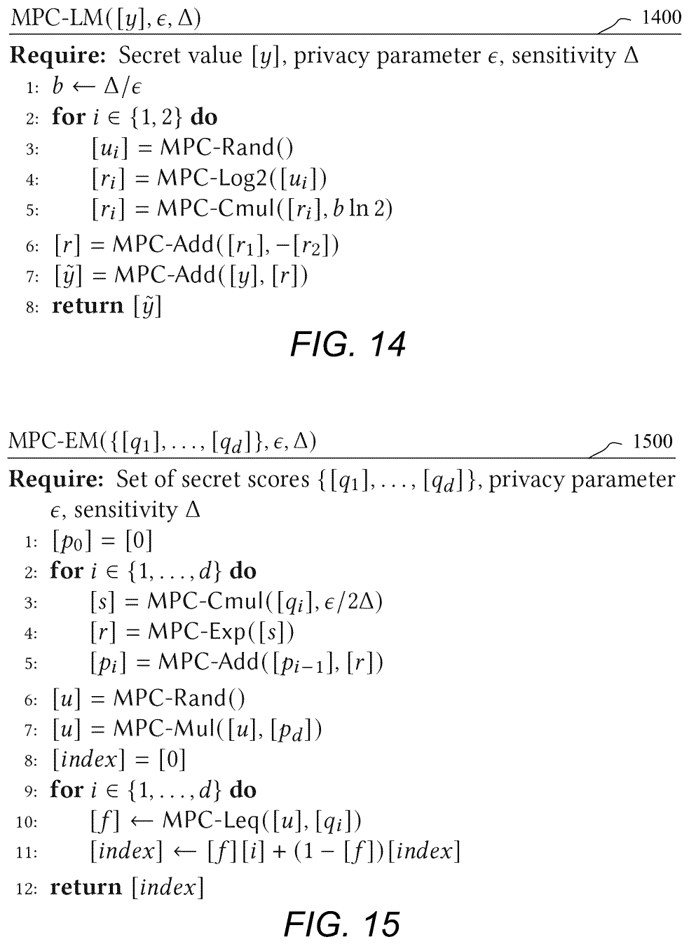

The key steps of Secure_ID3 tree generation protocol as shown in FIG. 2 are as follows:
Compute the class partitions and frequencies (Steps 5-6): derive a binary vector Ci for each class i. C_{i,j}=1 implies the j-th tuple belongs to class i, and 0 otherwise. These vectors are used to derive class frequencies which are stored in τ. Each frequency is randomized using the MPC-LM protocol as shown below in FIG. 14.
Check the stopping condition and derive the majority class (Steps 7-11): When h reaches 0, a privacy-preserving tree generation protocol computes the majority class label returned as the leaf label.
Compute the quality scores (Steps 12-14): the Cᵢ vectors derived from the previous steps are used by the MAX protocol as discussed below in FIG. 3. At step 14, the scores for the available attributes are kept unchanged, but the scores for the other attributes are set to 0 so that these attributes would not be chosen for the current node.
Select the best attribute and its encoding (Steps 14-19): the arg max protocol returns the index of an attribute whose quality score is the maximum. At step 16, the index is converted into a vector representation using the Indicator protocol as discussed below in FIG. 4. Then one-hot encodings of Aₖ are retrieved and stored in X.
Partition the data and recursively build sub-trees (Steps 20-22): At step 21, [T]×[Xᵢ] produces a binary vector that represents the data partitioned based on Ak,i. [ [symbol] ]−[k] means that the chosen attributed is removed from further consideration. Then a sub-tree is built with each data partition with tree height reduced by one.

As stated before, the dummy values are represented as zero vectors. As a result, they have no effect on the MAX protocol of FIG. 3 and the quality scores for all attributes are unaffected by the dummy values. Although the resulting tree model has branches generated from these dummy values, they do not interfere with or affect the result of model inference tasks according to the prediction protocol shown below in FIG. 6.

Quality metric. There are various quality metrics that determine the best split. In the context of DP, since the choice of quality metrics affects the model accuracy, the max operator, which has a lower sensitivity, has shown a better performance than the other metrics. For this reason, the max operator may be considered as the quality metric for choosing the best split attribute. The max operator corresponds to the misclassification rate by picking the class with the highest frequency, which has the sensitivity of 1:

$$q ( D , A ) = {\sum }_{a ∈ A} ( {max}_{c} \vert {D}_{A = a , C = c} \vert ) \qquad ( 1 )$$

The MAX protocol 300 as shown in FIG. 3 is the MPC implementation of the max operator according to Equation 1. FIG. 3 is a block diagram providing pseudocode illustrating a protocol for determining a score for an attribute, according to some embodiments. In at least one embodiment, each class is assigned an associated value determined as a highest frequency (step 2), and then a score for an attribute is determined by summing the respective highest frequencies for the encodings of the attribute (step 3).

FIG. 4 is a block diagram providing pseudocode illustrating a protocol for converting an index into a vector, according to some embodiments. In at least one embodiment, an Indicator protocol 400 may identify attributes that are identified by a given index i and set a corresponding position in a vector with a binary value (step 2). The vector may then be returned in step 3.

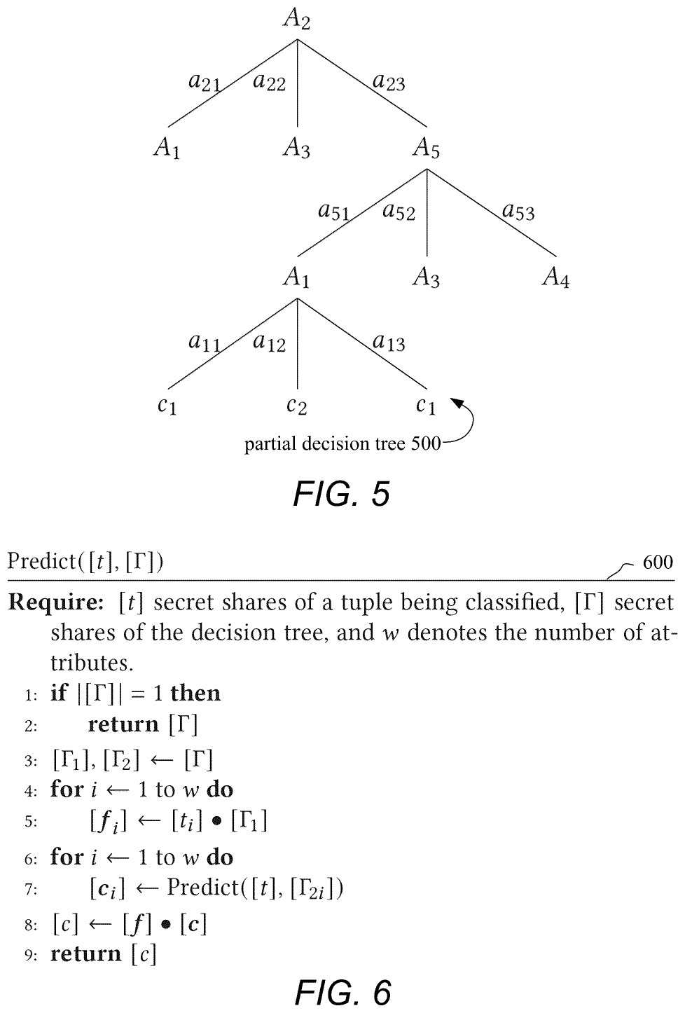

FIG. 5 is a block diagram illustrating a partial decision tree, according to some embodiments. In at least one embodiment, a partial decision tree 500 may include a leaf tier (c1, c2), a root tier (A2) and zero or more non-leaf tiers such as [A1, A3, A5] and [A1, A3, A4]. Through selective padding, all parent nodes of the partial tree will have a same number of child nodes (three in the example case) with the exception of leaf nodes which may not have child nodes.

For MPC protocols, asymptotic complexity is often based on the number of secure multiplications (SM). Since secret sharing-based secure addition does not require communication, its complexity is negligible comparing to SM. First, analyze the complexity for each sub-protocol and let I represent the share size in bits:
arg max([x]): this protocol can be implemented using |[x]|−1 secure comparisons (SC), each of which has a complexity of O(l). Thus, the complexity for arg max is O(l|[x]|).
MAX ([Dᵢ], [C],u,w)→[γᵢ]: since Cᵢ has a size of n, each secure dot product requires n SMs. There are u dot products. The max protocol can be implemented using u−1 SCs. As a result, the total complexity for the MAX protocol is O((n+l)wu).
Indicator (m, [k])→[k]: a privacy-preserving tree generation protocol requires m SCs, so it complexity is bounded by O(lm).

Next, referring back to FIG. 2, estimate the complexity of various portions of a privacy-preserving tree generation protocol:
Steps 5-8: there are u component-wise secure multiplications with size n each, so that complexity is O(nu).
Steps 9-10: the size of τ isu; thus, the complexity is bounded by O(lu).
Steps 12-13: since MAX is called m times, the complexity is O(m(n+l)wu).
Step 14: requires O(m) SM operations.
Step 15: the size of γ ism; thus, the complexity is bounded by O(lm).
Step 16: the complexity is O(lm).
Steps 17-19: there are wn secure dot products of sizem, so the complexity is bounded by O(mnw).
Steps 20-22: there are w recursive calls, and before each call, a secure component-wise vector multiplication is performed. As a result, the complexity is bounded by O(nw) before performing the recursive calls.

It is clear that the complexities at 13-15 and 19-23 dominate the rest of a privacy-preserving tree generation protocol before each recursive call. In addition, since the vector sizes do not change for all recursive calls, the total complexity is bounded by: O(w^{h-1}(m(n+l) wu), for 1≤h≤m.

Security Analysis. Under the semi-honest model, it is easy to prove the proposed protocol protects the training data since all operations are performed over secret shares and no intermediate results are ever disclosed. Nevertheless, it is challenging to prove the DP guarantee. In the proof, it may be shown why it is sufficient to add less noise at the leaf level which provides a theoretic justification on the effectiveness of the proposed approach.

Let [symbol] =A₀, A₁, A₂, A₃, A₄, A₅ where A₀ is the class attribute. Ignoring the class attribute, the rest can be represented as indicator vectors {10000, 01000, 00100, 00010, 00001} from A₁ to A₅ respectively. Suppose that each attribute Aᵢ has three values represented by {100, 010, 001}, corresponding to {aᵢ₁, aᵢ₂, aᵢ₃} respectively or the tree branches from left to right. Let Γ={Γ₁, Γ₂}={Γ₁, {Γ₁, Γ₂₂, Γ₂₃}} represent a decision tree where Γ₁ is the root attribute and Γ₂ is a set of children nodes of Γ₁. If Γ₁ is a leaf node, then it is set to c, one of the class labels; otherwise, it is defined recursively. As an example, a partial tree 500 is given in FIG. 5. The complete tree is full 3-nary tree; that is, each internal node has three branches. Due to space limitation, only part of it may be presented. According to FIG. 5, Γ₁ represents A₂ as the chosen root of Γ, then Γ₂₁, Γ₂₂ and Γ₂₃ correspond to the sub-trees rooted at A₁, A₃ and A₅ respectively. Γ₁ is represented using A₂'s indicator vector 01000. Let a tuple t=[2, 3, 3, 1, 1] represented as a 3-by-5 matrix:

$$[ \begin{matrix}0 & 0 & 0 & 1 & 1 \\ 1 & 0 & 0 & 0 & 0 \\ 0 & 1 & 1 & 0 & 0\end{matrix} ]$$

ti indicates the i-th row of the matrix, and |ti| gives the number of attributes. The number of rows in t is denoted by w specifying the domain size of each attribute. In this example, |ti|=5 and w=3.

FIG. 6 is a block diagram providing pseudocode illustrating a protocol 600 for making predictions using secret shares of a decision tree, according to some embodiments. In at least one embodiment, protocol 600 derives the class label of a secretly shared record t recursively. The tree Γ is also secretly shared based on its smallest elements. For example, Γ₁ is secretly shared component-wise of A₂'s indicator vector at the top level of the tree. This recursively applies to the other levels. At the leaf level, the class label c is secretly shared. The tree structure, a complete w-nary tree, is preserved, so that it can easily be checked if Γ is a tree or a leaf node. At step 1 of a privacy-preserving tree generation protocol. |[T]|=1 indicates that Γ is a leaf node, and its class label is returned. Otherwise, [Γ] is decomposed into two components Γ₁ and Γ₂. At steps 5-7, a privacy-preserving tree generation protocol retrieves the correct attribute at the current root whose values serve as flags to indicate the right prediction path. At steps 8-10, a privacy-preserving tree generation protocol makes w recursive calls on the sub-trees. At the end, the results from each sub-recursive calls are combine to produce the shares of the class label. The key observation is that there is only one path in the tree whose associated ƒi values are all one. As a result, the results returned from all other paths are 0, and the result from the correct path is preserved.

Various embodiments for building a differentially private decision tree are described. Utilizing MPC, a decision tree may be kept hidden even during model prediction. As a result, a differentially private decision tree building technique achieves (1) data privacy, (2) high model accuracy, (3) model confidentiality and (4) query privacy. In at least one embodiment, a stopping condition of the fully secure ID3 protocol adopted herein only depends on a tree depth which can lead to a different model comparing to a standard ID3 algorithm. It is possible to design a different fully secure ID3 that can produce the same outcome as the non-secure ID3. In addition, the efficiency of the prediction protocol may be improved by directly using secret shares to represent attributes for the internal nodes instead of unary representation. In at least one embodiment, a more precise DP bound for the random forest may be able to be derived by utilizing the additional randomness among the sub-samples.

A private dataset D may be considered where each column and row correspond to an attribute and a sample respectively. There are d attributes [symbol] ={A₁, . . . , A_{d}} and a class attribute C. The domain of each attribute Aᵢ a finite, denoted as dom(Aᵢ). All attributes may be considered that are composed of discrete variables. Namely, continuous attributes are discretized. The discretization is a common pre-processing technique used in machine learning and data science fields. In addition, the schema (e.g., number of attributes, attribute domains, domain sizes) is considered public. For v∈dom(Aᵢ), denote |D_{A}_{ᵢ₌ᵥ}| as a subset of samples whose attribute Aᵢ is equal to v. In addition, denote |D_{A}_{ᵢ₋ₓ}| as the number of samples in D_{A}_{ᵢ₋ₓ}. Write Nᵥ=|D_{A}_{ᵢ₋ₓ}| if the context is clear.

Differential Privacy. A dataset D may be considered that is a collection of individual data coming from the universe of all possible datasets [symbol] . Differential Privacy (DP) has become the de facto standard for privacy protection. DP is a mathematical privacy definition that guarantees the output of the mechanism will not differ significantly between any two neighboring datasets. Say D and D′ are neighbors, denoted as D˜D′, if they differ at most by one individual. It is formally defined as follows.
Definition 2.1 ((ε, δ)-Differential Privacy) A randomized mechanism [symbol] is (ε, δ)—differentially private if for all output O∈Range( [symbol] ) and for any two neighboring datasets D˜D′∈ [symbol] ,

$$Pr [ ℳ ( D ) = O ] \leq {e}^{ϵ} Pr [ ( {D}^{′} ) = O ] + δ$$

when δ=0, say [symbol] satisfies ϵ-DP.

The privacy parameter ϵ is referred to as the privacy loss budget where a smaller value of e gives more privacy protection but can lower data utility. DP is typically achieved by a noise-addition mechanism where a carefully calibrated noise is added to the outcome of a function ƒ. The magnitude of the noise is controlled by the privacy parameter e and function sensitivity Δ_{ƒ} defined below.
Definition 2.2 (Sensitivity) The sensitivity Δ_{ƒ} of a function ƒ: [symbol] → [symbol] is defined as Δ_{ƒ}=max_{∀D˜D},|ƒ(D)−ƒ(D′)|

A common mechanism for outputting a real number is to use the Laplace mechanism where a noise is added, denoted as Lap(b), sampled from the Laplacian distribution with the mean of 0 and a scale of b=Δ_{ƒ}/ϵ. Denote Lap(⋅)^{l} as l independent Laplacian noise. It is well known that the following Laplace mechanism satisfies ϵ-DP.
Definition 2.3 (Laplace mechanism) Given a function ƒ: [symbol] → [symbol] ^{l}, the mechanism that outputs ƒ(D)+Lap(Δ_{ƒ}/ϵ)^{l} satisfies ϵ-DP.

For a private selection over discrete values or items, the Exponential mechanism can be used. Given a finite set of candidates [symbol] and an associated quality score function q: ( [symbol] × [symbol] )→ [symbol] , the Exponential mechanism aims to return a candidate r∈ [symbol] that approximately maximize q(D,r) while enforcing DP. The quality function is typically a way of measuring the quality of the candidate r with respect to data D, where higher scores are better. It induces a probability distribution over the output domain that favors high scoring outcomes. In other words, candidates that have higher scores are exponentially more likely to be chosen. It is well known that the following Exponential mechanism satisfies ϵ-DP.
Definition 2.4 (Exponential mechanism) Given a quality {or scoring) function q( [symbol] ×R)→ [symbol] , the mechanism [symbol] defined as follows satisfies ϵ-DP.

$$Pr [ ℳ ( D ) = a ] ∝ exp ( \frac{eq ( D , a )}{2 {Δ}_{q}} )$$

DP mechanisms have the following properties: a post-processing property states that all subsequent analyses on outputs produced by ϵ-DP mechanism satisfy ϵ-DP, without degrading privacy loss. Additionally, a sequential composition property implies that if two query sets are answered under ϵ₁ and ϵ₂, respectively, the combined answers satisfy (ϵ₁+ϵ₂)-DP. Parallel composition says that given a dataset D, a disjoint partition D=D₁∪, . . . , ∪Dₖ and ϵ-DP mechanism [symbol] the mechanism [symbol] ′^{(D)}=( [symbol] (D₁), . . . , [symbol] (Dₖ) satisfies ϵ-DP.

Tree-Based Model. Although an ID3-based classification algorithm is used, these techniques are applicable to other variants such as CART, C4.5 or random forests. The general frameworks of these algorithms are the same where they are all greedy algorithms that find an optimal decision and recursively building a tree.

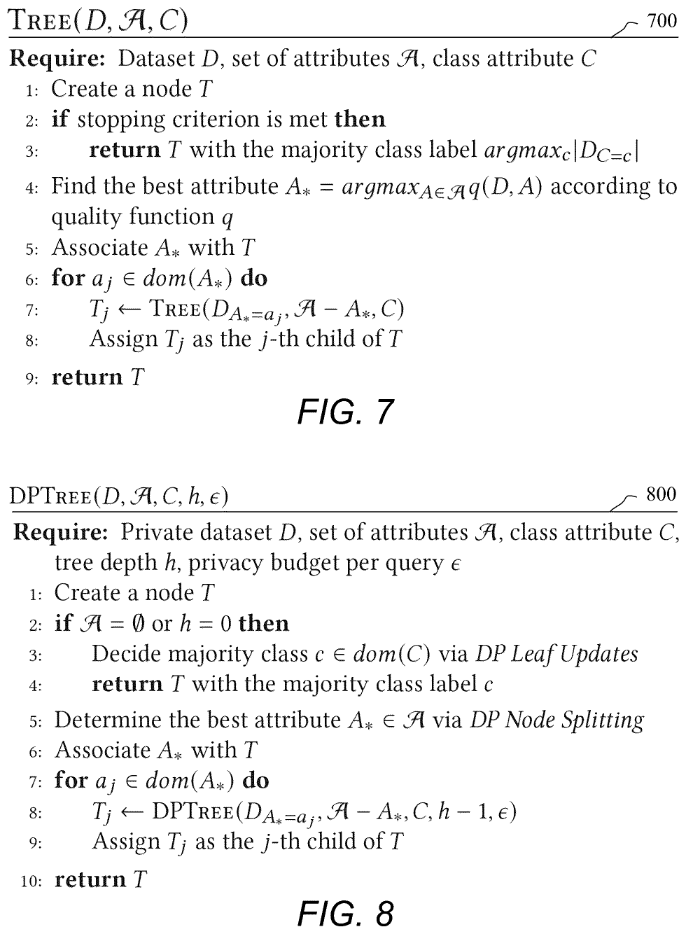

FIG. 7 is a block diagram providing pseudocode illustrating a recursive technique for generating a decision tree 700, according to some embodiments, where a tree is built from root to leaves recursively. It first checks if some stopping criterion is satisfied (e.g., attribute set is empty, tree reaches the maximum depth, the number of samples is less than a threshold). If any stopping criterion is satisfied, the algorithm returns a leaf node with the class of majority samples. Otherwise, it determines the best splitting attribute A_{⋅}∈A for the parent node, according to some quality measure q, and splits the samples with that attribute. The same process is applied recursively on each subset of the samples.

FIG. 8 is a block diagram providing pseudocode illustrating a recursive privacy-preserving technique for generating a decision tree 800, according to some embodiments, using a technique that extends the technique of FIG. 7 with DP to limit the individual-level privacy leakage about the training dataset that the decision tree learns. In a typical DP decision tree learning problem, the tree is assumed to be released publicly. Thus, to provide a DP guarantee, a noise is added whenever a sensitive data D is queried to construct the tree. While there are many strategies, key components that require adding some form of noise or DP consideration are: node splitting (i.e., which attribute to split a node with), and leaf updates (i.e., compute leaf weights or labels for prediction).

DP Node Splitting. To choose the best split attribute with DP guarantee, the most common and efficient technique is to use the Exponential mechanism where the best attribute is selected with a high probability based on a specified quality metric [14 For example, the attribute that has the lowest Gini index is chosen with a high probability. More formally, given a dataset D, a set of attributes [symbol] , a quality function q:( [symbol] × [symbol] )→ [symbol] , the best attribute A_{best}∈ [symbol] is outputted with probability∝

$$exp ( \frac{ϵ q ( D , {A}_{best} )}{2 {Δ}_{q}} ) .$$

DP Leaf Updates. Consider two common DP approaches of deciding the majority label of each leaf node. The first method is based on private counting using the Laplace mechanism and the second method is based on private selection using the Exponential mechanism, detailed below.

Private Counting. The first approach is to use the idea of private counting where for each leaf node, generate noisy class counts using the Laplace mechanism and determine the majority class label based on the resulting noisy counts. Namely, the majority label is selected by computing argmax_{c∈dom(C)} {|D_{C=c}|+Lap(1/ϵ)}.

Private Selection. The second approach is to use the Exponential mechanism to determine the majority label using counts as a quality function. Given a dataset D, a class attribute C, a counting query q:D×dom(C)→N, the majority class label cₘₐₓ∈dom(C) is selected with probability∝

$$exp ( \frac{ϵ q ( D , {c}_{max} )}{2 Δ q} ) ,$$

where Δq=1 (the sensitivity of a counting query is 1).

In the privacy-preserving technique 600 of FIG. 6, in at least one embodiment a data independent stopping criterion may check if the attribute set is empty or the tree reaches the predefined depth, to avoid spending additional privacy budget.

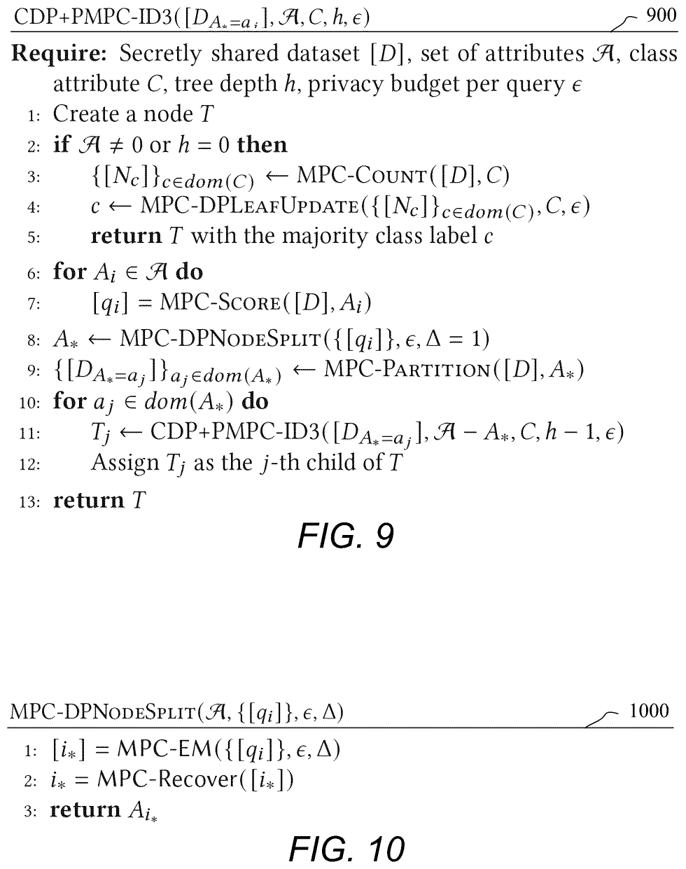

FIG. 9 is a block diagram providing pseudocode illustrating a recursive privacy-preserving technique for generating a node of a DP decision tree with MPC 900, according to some embodiments. A trained model including split attributes and output class labels are safely revealed in a plaintext format with DP guarantees during a privacy-preserving tree generation protocol execution. Since the resulting model satisfies DP, it can be shared with a third party in plaintext without degrading privacy, but this does not achieve model confidentiality.

Centralized DP Decision Tree Learning with Partial MPC

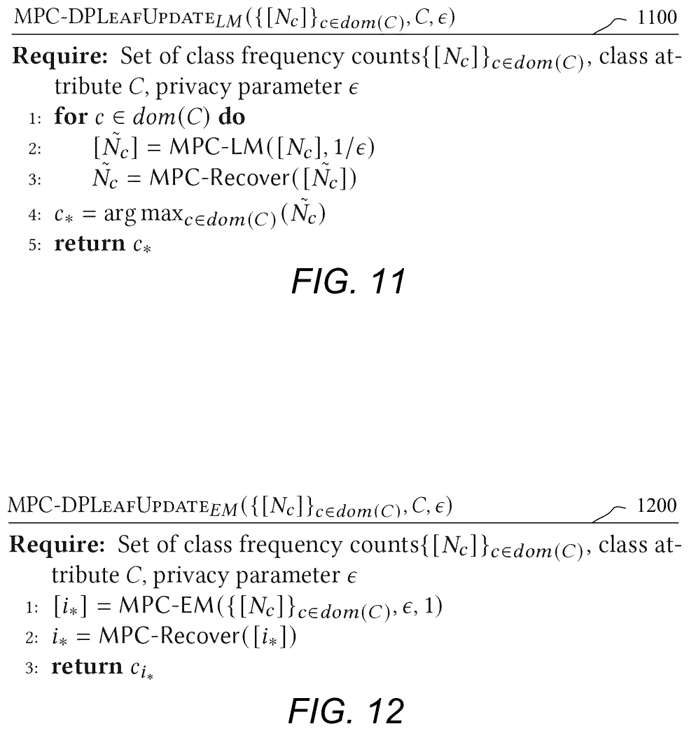

FIG. 9 shows a recursive privacy-preserving technique for generating a node of a DP decision tree with MPC 900, the technique training a DP decision tree model on a secret shared data [D] with an MPC framework. At each non-leaf node, quality metrics (i.e., the max operator) of candidate attributes [symbol] are computed using MPC-Score. The best split attribute is decided under DP with MPC and revealed as a plaintext, as discussed in further detail in FIG. 10 below. With the best attribute A_{•}, the MPC-Partition protocol secretly partitions [D] into |dom(A_{•})| disjoint datasets such that each data subset includes all samples whose A_{•}=a for every a∈dom(A_{•}). Note that [D_{A•=a}] is a symbolic notation: it does not mean the data are actually decomposed. It typically requires some form of secret indicators of whether a sample belongs to a certain node. Meanwhile, for each leaf node, frequency counts of each class label are computed using MPC-Count. With the resulting secretly shared counts, the majority class label is determined under DP with MPC and revealed as a plaintext, as discussed in further detail in FIG. 11 below.

A key observation is that any intermediate secretly shared values in which DP noise is incorporated are safely revealed in a plaintext format under a DP guarantee during a tree construction. This as an advantage to make a privacy-preserving tree generation protocol as efficient as possible, which will be detailed below. Since a DP decision tree is trained on top of MPC, the model accuracy provided by 1000 is theoretically the same as that of (non-MPC) DP decision tree provided by 900. However, in practice, there might be some small discrepancy in accuracy due to the quantization of DP mechanism when implemented with a secret sharing scheme. MPC-Count, MPC-Partition and MPC-Score are left as black box operations. The actual instantiations will be described later.

DP Node Split and Leaf Update with MPC

Here the details of DP node split and DP leaf update operations using an MPC protocol to hide the training data are described. The effect of DP on MPC protocols may be observed from the perspective of efficiency, and there is a key distinction between the Laplace mechanism and the Exponential mechanism in the efficiency aspect when incorporated into an MPC tree building process, especially for the DP leaf update.

DP Mechanisms with MPC. The implementation of DP mechanisms, including the Laplace mechanism and the Exponential mechanism with secret-sharing based MPC, has been studied in prior works, which will use for the implementation. Denote MPC-LM ([x], b) as an MPC version of Laplace mechanism where secretly shared value of Laplacian noise Lap(b) is sampled and then added to a secretly shared value of x to generate a secretly shared value of x+Lap(b). No one learns any information about either input x or noise Lap(b).

In addition, denote MPC-EM ({[q₁], . . . , [q_{d}]}, ϵ, Δ) as an MPC-version of the Exponential mechanism, which privately selects the i-th item among d items based on their associated secret share values of the quality scores {q₁, . . . , q_{d}} of a function q. According to Definition A.4, the i-th item is returned with the probability proportional to exp(ϵqᵢ/2Δ). The output index i is secretly shared. Detailed implementations of both DP-mechanisms are discussed below

FIG. 10 is a block diagram providing pseudocode illustrating a protocol for splitting a node of a decision tree, according to some embodiments. DP Node Split 1000 may perform a DP node split using an MPC framework for a non-leaf node. Given secret shares of quality metrics, computed based Equation 1 (see FIG. 3 above), the Exponential mechanism MPC-EM secretly and noisily chooses the approximate best attribute. Recall that the sensitivity of the max operator is 1, i.e., Δ=1. By executing the MPC-Recover, the resulting attribute is safely revealed in a privacy-preserving tree generation protocol as plaintext since it satisfies DP without further degrading privacy.

DP Leaf Update: Exponential Mechanism vs Laplace Mechanism. In at least one embodiment, DP leaf update with MPC is shown, given secret shares {[N_{c}]}_{c∈dom(C)} of class frequency counts at a leaf node. Two approaches may be considered, one is based on the Laplace mechanism and the other is based on the Exponential mechanism. FIG. 11 is a block diagram providing pseudocode illustrating a protocol for updating a leaf in a decision tree using a Laplace mechanism 1100, according to some embodiments, and FIG. 12 is a block diagram providing pseudocode illustrating a protocol for updating a leaf in a decision tree using an exponential mechanism 1200, according to some embodiments.

A key observation is that for the Laplace mechanism based approach, after computing secret-shared DP counts, DP counts may be revealed safely. As a result, the subsequent argmax operation is computed in the clear. Revealing the DP counts will not degrade the privacy loss. Furthermore, introducing DP into MPC enables eliminating an expensive MPC argmax operation that would be required in an MPC-only computation. Note that this does not mean the DP-MPC approach is more computationally efficient than the MPC-only approach as it has an extra complexity of computing the Laplace noise. However, since the Laplace noise generation is data-independent, when considering an online-offline setting, the DP-MPC approach would provide a better online efficiency than the MPC-only approach. On the other hand, the Exponential mechanism-based leaf update does not provide such an efficiency gain as it is data-dependent. Since the Laplace mechanism and the Exponential mechanism for leaf updates incur the same privacy cost, one may prefer the Laplace mechanism 1100 for efficiency.

Instantiation. As mentioned above, a privacy-preserving tree generation protocol completely hides training data except for information leaked from a tree output. Since a tree generation protocol reveals a tree, e.g. attribute splits and output class labels, such a protocol is a good candidate to use privacy-preserving techniques of FIG. 9 such that a constructed DP tree can be safely disclosed. In general, the technique of FIG. 9 may be constructed with any MPC decision tree protocols in combination with the MPC-DP mechanisms to produce a tree as plaintext.

A secret shared dataset [D] is represented as secret shares of one-hot encodings of length n for attribute A. That is, DA is one-hot encoded into n-by-|dom(A)| binary matrix. Note that the max operator defined in Equation 1 and FIG. 3 may be used for MPC-Score.

Data Pre-processing. Before executing the model generation protocol, each data owner needs to locally pre-process its data. In some embodiments, assume that data owners apply consistent pre-processing strategies, such as discretization, handling missing values, etc. In addition, data integration at the servers can be tricky. Under the vertical partition scheme, the data owners generate one-hot encodings for their attributes and then secretly share the encodings with the three computing servers. The guaranteed easily even if they do not know the data schema and attribute domains.

Under horizontal partition, it becomes more challenging to integrate the shares depending whether or not the schema is known. In some embodiments, it is assumed that the schema, including each attribute domain, is known to the participating parties, then each party produces the one-hot encoding based on its own data. When locally producing the encodings for each attribute, the parties follow certain ordering of the attribute values. For example, the attribute may be sorted alphabetically and then map them to successive non-negative integers starting from 0 or 1. Suppose there are w distinct values for attribute Aᵢ. Under horizontal partition, Aᵢ is a feature owned by all parties. The key steps to generate and integrate the encodings of Aᵢ are presented in FIG. 13.

FIG. 13 is a block diagram providing pseudocode illustrating a protocol for integrating private encodings of attributes into a global domain 1300, according to some embodiments. If parties do not know a complete attribute domain, more advanced MPC protocols may be needed to align the one-hot encodings without leaking the additional domain knowledge. Developing efficient one-hot encoding alignment protocols are orthogonal to the work, and the basic idea is to utilize private set intersection protocols to obliviously link the encodings that represent the same attribute value together. Moreover, a privacy-preserving tree generation protocol hides the tree structure by enforcing each attribute has the same number of distinct values. Let w be the largest domain size among all attributes. Then each party needs to generate w one-hot encoding per attribute. For dummy attribute values, each party can simply generate zero vectors to represent the dummy values. When sorting the encodings, these zero vectors (per attribute) can be placed at the end of the encoding list for that specific attribute.

Privacy/Security Analysis. As stated before, a technique for implementing privacy-preserving generation of decision trees achieves (1) data privacy, (2) high model accuracy, (3) model confidentiality and (4) query privacy. High model accuracy may be demonstrated in two ways: theoretically prove less noise is needed to achieve the same level of DP, and

empirically justify the accuracy improvement using three real world datasets. For the others, prove the following:
The training data are not disclosed when building the tree.
The final tree model and user queries are never disclosed during prediction.
The tree is ϵ-DP.

The first two are straightforward to prove since the standard MPC functionalities to implement the MPC-DP mechanisms and the MPC-decision tree generation may be adopted. Intuitively speaking, nothing is disclosed during model generation and prediction, except that a user obtains the final prediction result. As long as the servers follow a privacy-preserving tree generation protocol and the secret sharing scheme is secure, so does a privacy-preserving tree generation protocol. On the other and, since the way of combining DP and MPC is new, it may be proved that resulting protocol satisfies ϵ-DP. The key idea is to show that when the tree structure is hidden, adding less amount of noise to the leaf nodes is sufficient to achieve the same level of DP comparing to the existing technique where DP noises are also added to the attribute selection process for the internal nodes. Let T₁ and T₂ are two decision trees with the following properties:
T₁: The tree structures are completely hidden including the leaf labels. In addition, before leaf labels are derived, noises are securely added to achieve ϵ-DP. During prediction, the users only learn the predicted result. The entire process can be achieved using MPC. (Note that T₁ may be more private than ϵ-DP since the leave labels are hidden.)
T₂: The tree structures are known but noises are added during tree generation process to achieve ϵ-DP. More specifically, MPC techniques are adopted to compute the scores for each attribute. Using MPC, noises are securely added to the scores before selecting the best split or attribute. After the selection, the chosen attribute is disclosed. Then the process repeats to build the rest of the tree. For prediction purpose, the DP-tree can be shared with the users.

When an adversary has black-box access to a decision tree model, the adversary can reconstruct the tree with very high accuracy by using a number of queries and their prediction results. As a result, even though T₁ is completely hidden from anyone, is it still possible for an adversary to reconstruct another tree \hat{T}₁ (with black-box access to T₁) that is less private than T₁ or T₂? The short answer is no because when deriving T₁, the sequential composition theorem and all intermediate computations and results are implemented using MPC protocols. If \hat{T}₁ is less private than T₁ or T₂, then either the composition theorem is incorrect or the MPC protocol leaks nonnegligible information. A more formal analysis is given next.

T₁ is ϵ-Differentially Private. Here is a proof that adding ϵ-DP noise at each leaf node independently guarantees T₁ is ϵ-DP. Let ƒ be the mechanism that securely selects the best attribute for the internal nodes of T₁:

ƒ([\vec{D}],[\vec{Λ}])→[\vec{D}ₗ],[\vec{D}ᵣ],[\vec{Λ}ₗ],[\vec{Λ}ᵣ],[a],[tₐ]

Without loss of generality, assume each attribute splits the data into two partitions: left and right denoted by \vec{D}ₗ and \vec{D}ᵣ respectively. All \vec{D}, \vec{D}ₗ and \vec{D}ᵣ are binary vectors with the same size bounded by the size of the dataset, and the [ ] notation indicates the vectors are secretly shared component-wise. \vec{Λ}, \vec{Λ}ₗ and \vec{Λ}ᵣ, and are also binary vectors with the same size determined by the number of attributes. The chosen attribute is denoted by a with threshold tₐ. All inputs and outputs of ƒ are secretly shared, and the height of the tree is fixed to a public parameter h indicating the tree has 0, 1, . . . , h layers. \vec{D}ₗ and \vec{Λ}₁ (or \vec{D}ᵣ and \vec{Λ}ᵣ) are inputs to build the left (or right) branch of the sub-tree rooted at a. [a] and [tₐ] are the actual output of each tree layer. Let g be a function for the leaf node:

g([\vec{D}])→[c]

where \vec{D} represents a set of tuples at the current leaf node and c is the class label for this node. The class label is chosen using the Laplace mechanism with privacy budget ϵ and sensitivity 1. Both \vec{D} and c are secretly shared. Based on ƒ and g, define a layer function L as follows:
Lk= [symbol] ƒ k 1, . . . , ƒ k 2k [symbol] , for k∈{0, h−1}.
Lh= [symbol] g1, . . . , g2h [symbol] .

Each layer is a parallel composition of either the ƒ or the g functions. Next show ƒ is 0-DP. Suppose \vec{D} and \vec{D}′ represent two neighboring datasets with the same vector size. (Note that they can be made the same size by adding a dummy entry to the smaller vector.) The ƒ function produces the following outputs on the two neighboring datasets D′ and D′:
ƒ([\vec{D}], [\vec{Λ}])→[\vec{D}ₗ], [\vec{D}ᵣ], [\vec{Λ}ₗ], [\vec{Λ}ᵣ], [a], [tₐ]
ƒ([\vec{D}′], [\vec{Λ}′])→[\vec{D}′ₗ], [\vec{D}′ᵣ], [\vec{Λ}′ₗ], [\vec{Λ}′ᵣ], [a′], [tₐ′]

The output of ƒ are secret shares from the same domain F. Since secret shares are uniformly random in F, the adversary cannot tell the difference between the two outputs. That is:

Pr(ƒ([\vec{D}], [\vec{Λ}])∈ [symbol] )=Pr(ƒ([\vec{D}ᵣ], [\vec{Λ}′])∈ [symbol] )

This implies that ϵ=0 and ƒ is 0-DP. In addition, since the layer function L^{k} is a parallel composition of independent calls of ƒ, the output distributions of L^{k} on two neighboring datasets are the same. Therefore, L^{k} is also 0-DP. The same analysis is applicable for g and L^{h}, and conclude L^{h} is 0-DP. Let p be the prediction function:
p([T₁], [τ])→c_{τ}
   where [T₁] indicates the secret shares of T₁, a collection of outputs from each layer function L^{k}, L^{h}, and τ is a secretly shared user record. Cr is the classification result only known to the user. Because the class labels are ϵ-DP, based on the robustness to post-processing property of DP, the prediction result is ϵ-DP, and so does T₁.

Another important consequence of the above proof is that since noise is only added at the leaf level, the total amount of noise added to the tree in the approach is significantly less than the existing technique.

Consider MPC for the Laplace mechanism and the Exponential mechanism. Random numbers may be secretly sampled from appropriate distributions using basic MPC operations. The approaches of constructing the two DP mechanisms using secret sharing-based MPC are discussed below. It may be assumed that the following basic MPC functionalities are available: addition add, multiplication mul, multiplication-by constant cmul, exponentiation exp, a binary logarithm log 2, random number generator between 0 and 1 rand, and comparison leq. Denote [x] as a secret shared value of x.

FIG. 14 is a block diagram providing pseudocode illustrating a protocol for privacy-preserving noise generation using a Laplace mechanism 1400, according to some embodiments. Recall that the Laplace mechanism samples noise from the Laplace distribution Lap(b) with a scale parameter b=Δ/ϵ, where Δ is a query sensitivity and ϵ is a privacy loss parameter. In at least one embodiment, a technique as shown in FIG. 14 generates Lap(b) in a secret share format and adds the secret noise to a secret share value of y. Namely, it performs \tilde{y}=y+Lap(b) with MPC.

The idea is to sample a noise from the Laplace distribution using an inverse transform sampling with the exponential distribution. That is, the Laplace distribution can be viewed as the double exponential distribution, and it holds that X₁−X₂˜Lap(b) where X₁ and X₂ are independent and identically distributed Exp(1/b). In addition, using an inverse transform sampling, have Exp(1/b)=−b ln [symbol] , where [symbol] is a uniform random variable in (0, 1). Thus, a random variable Y with distribution Lap(b) can be created by:

$$Y = b ln {𝒰}_{1} - b ln {U}_{2}$$

where [symbol] ₁ and [symbol] ₂ are independent and identically distributed uniform distribution on (0, 1).

FIG. 15 is a block diagram providing pseudocode illustrating a protocol for privacy-preserving noise generation using an exponential mechanism 1500, according to some embodiments. In at least one embodiment, a technique as shown in FIG. 15 may implement an exponential mechanism with MPC when given secret-shared quality scores of d candidate items. Similar to the Laplace mechanism, the technique may implement the Exponential mechanism by only using the basic functionalities that MPC supports. The idea is as follows. Given a set of d items {a₁, . . . , a_{d}} and a quality function q, first compute

$${p}_{{a}_{i}} = \frac{exp ( \frac{ϵ q ( D , {a}_{i} )}{2 {Δ}_{2}} )}{{\sum }_{i}^{d} ( exp ( \frac{ϵ q ( D , {a}_{i} )}{2 {Δ}_{q}} ) )}$$

for each aᵢ. Then, compute d intervals of the cumulative probabilities {p₁, . . . , p_{d}} where p₁=pₐ_{ᵢ} and pᵢ=pᵢ₋₁+pₐ_{ᵢ} for 2≤i≤d. By sampling a uniform random number between 0 and 1 from U, return item aᵢ if the random number falls into the i-th interval, i.e., pᵢ₋₁<u≤pᵢ.

In the technique of FIG. 15, there is an option whether returning a selected index as a plaintext or a secret-shared value. If the index cannot be revealed, linearly scan all the items (Line 9-16). Otherwise, perform an efficient binary search to find the index.

Two different DP methods may be implemented for leaf updates, one is based on the Laplace mechanism and the other is based on the Exponential mechanism. If not mentioned explicitly, the Laplace mechanism may be used for DP leaf updates since it may be observed that the Laplace mechanism tends to offer a better accuracy than the Exponential mechanism. In addition, when implementing CDP+PMPC-ID3, the Exponential mechanism may be used to select the best attribute since it is efficient. The MPC-ID3 protocol works over integers where 32-bits may be used for the size of secret share, in some embodiments. For CDP+PMPC-ID3 and ODP+FMPC-ID3, to handle real numbers needed for the DP mechanisms, fixed point numbers may be used where the size of secret share is set to 32-bits for some datasets and 50-bits for other datasets. It should be understood, however, that these are merely example data size, that bit sizes may depend on data sets used independent of the described update mechanism, and that any number of data sizes, bit sizes and data formats may be used in various embodiments.

MPC-based Laplace mechanism and the Exponential mechanism may be implemented using MPyC or other MPC libraries. For the Laplace mechanism, the implementation of FIG. 14 may be used. When searching a selected item, perform an oblivious search by linearly scanning items since the selected index needs to be hidden instead of performing a binary search as in. In addition, use the common exp-normalize trick to prevent overflow where the maximum utility (i.e., the maximum quality score among the qᵢ is used in the MPC-Exp sub-protocol of FIG. 15) is subtracted from the quality scores. This trick is also used in the Diffprivlib library. To handle exponent underflows, for large negative numbers, clip the values to return zeros. Note that although the secret share size can be increased to handle overflow and underflow issues, this can easily result in computational infeasibility due to the expensive cost of secure exponentiation operations.

Using MPyC, basic arithmetic operations required for the DP mechanisms may be implemented, including the secure evaluation of an exponential function and a logarithmic function. For accuracy evaluation that does not require MPC, use the Laplace mechanism and the Exponential mechanism from the Diffprivlib library.

In at least one embodiment, a MPC+DP decision tree framework may be extended to random forest. Recent works on a DP random forest implement a DP version where a split attribute is randomly chosen. (This term for this specific algorithm may be extra trees.) Thus, DP noise is only introduced at leaf nodes. However, unlike its non-DP version, each tree trains on a disjoint subset of the data (i.e., bootstrap without replacement), which allows use of parallel composition. That is, as long as each tree is ϵ-DP, so is the random forest. On the other hand, implementing a DP version of random forest in the centralized setting is not privacy budget-efficient compared to the above DP extra trees because the best split needs to be determined under DP. By introducing MPC, the technique can provide a DP random forest without spending a privacy budget on split nodes.

Implement the extra trees-based DP random forest and ID3-based DP random forest in some embodiments. For each approach, the maximum depth can be varied (e.g., from 2 to 5) and the number of trees (e.g., from 1 to 10). Note that increasing the number of trees does not necessarily help to improve the accuracy especially for small datasets since each tree gets trained on a very small number of samples.

Parameter Selection and Privacy Amplification. Consider how to distribute the privacy budget e among the trees in the forest and how the number of trees affects the selection of E. First, prove the following claim: Claim D.1. Let γ be a sampling rate in (0,1) and k be the number of trees in a random forest. If each tree is built using ODP-FMPC-ID3 on a subset of data randomly generated with Poisson sub-sampling with rate γ and privacy budget E, then the resulting random forest achieves κγϵ-DP in the worst case.

To prove the claim, if a mechanism M is ϵ-DP, it achieves at least γϵ-DP when applying to a subset of data sampled with Poisson sub-sampling with sampling rate γ. Thus, each tree produced by ODP-FMPC-ID3 achieves γϵ-DP. If each tree is treated as produced sequentially, then the random forest is generated by a sequence of γϵ-DP mechanisms. Applying the sequential composition theorem, the random forest achieves κγϵ-DP. This is the worst case since the sequential composition theorem assumes the mechanisms apply to the same dataset. However, in one case, the sub-datasets are randomly sampled. Based on the claim, to achieve ϵ-DP, set γ=1/κ.

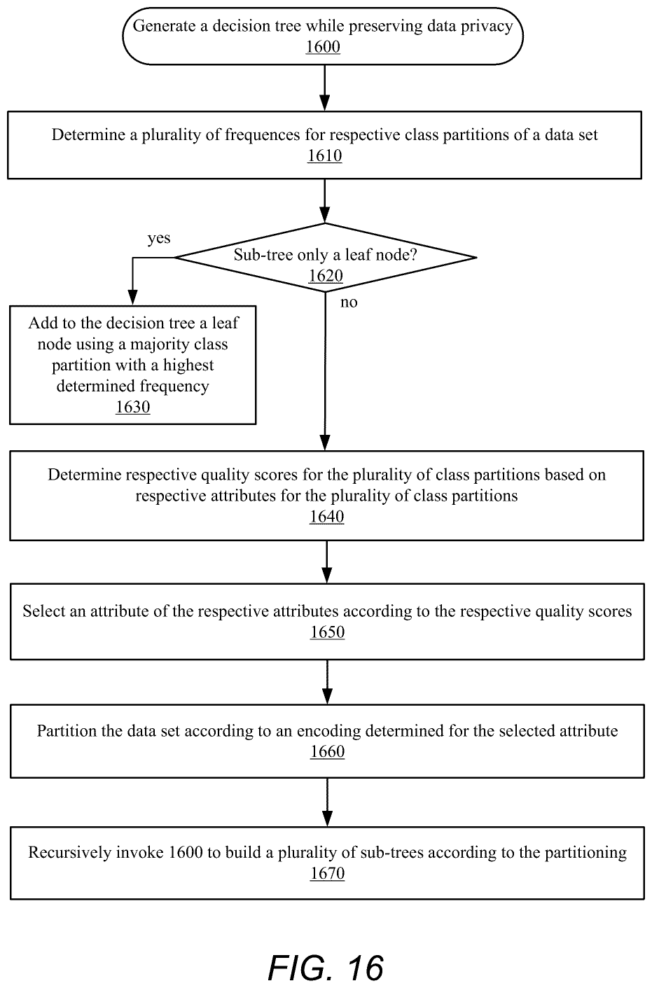

FIG. 16 is a high-level flowchart illustrating techniques to implement privacy-preserving decision trees using secure multiparty computation and differential privacy, according to some embodiments. These techniques may be implemented on various machine learning systems, services, or platforms, or those that incorporate machine learning techniques.

In at least one embodiment, a privacy-preserving protocol to recursively generate a decision is shown in 1600. As shown in 1610, in at least one embodiment a plurality of frequencies for respective class partitions of a data set may be determined. In at least one embodiment, class partitions and frequencies may be computed, as shown in steps 5-8 of FIG. 2 above, an MPC-LM protocol as shown in FIG. 14.

Then, as shown in 1620, a determination may be made if the tree is to include only a leaf node, in at least one embodiment. If the tree is to include only a leaf node, as indicated by a positive exit from 1620, the process may advance to 1630. If, however, If the tree is to include at least one non-leaf node, as indicated by a negative exit from 1620, the process may advance to 1640.

As shown in 1630, in at least one embodiment a leaf node made be created and added to the decision tree, the leaf node including a majority class partition with a highest determined frequency as determined in 1610. The process is then complete.

As shown at 1640, respective quality scores for the plurality of class partitions based on respective attributes for the plurality of class partitions may be determined, in some embodiments. In at least one embodiment, quality scores may be computed, as shown in steps 12-13 of FIG. 2 above, according to a MAX protocol as shown in FIG. 3.

As indicated at 1650, in at least one embodiment an attribute of the respective attributes may be selected according to the respective quality scores. A protocol may be executed to return the index of an attribute whose quality score is the maximum, as shown in step 15 of FIG. 2. At step 16 of FIG. 2, the index may then be converted into a vector representation using the Indicator protocol as discussed in FIG. 4.

As indicated at 1660, in at least one embodiment a data set may then be partitioned according to an encoding determined for the selected attribute, such as shown in step 21 of FIG. 2. A sub-tree may then be built for each data partition by recursively invoking the protocol 1600 using a tree height reduced by one. The process is then complete.

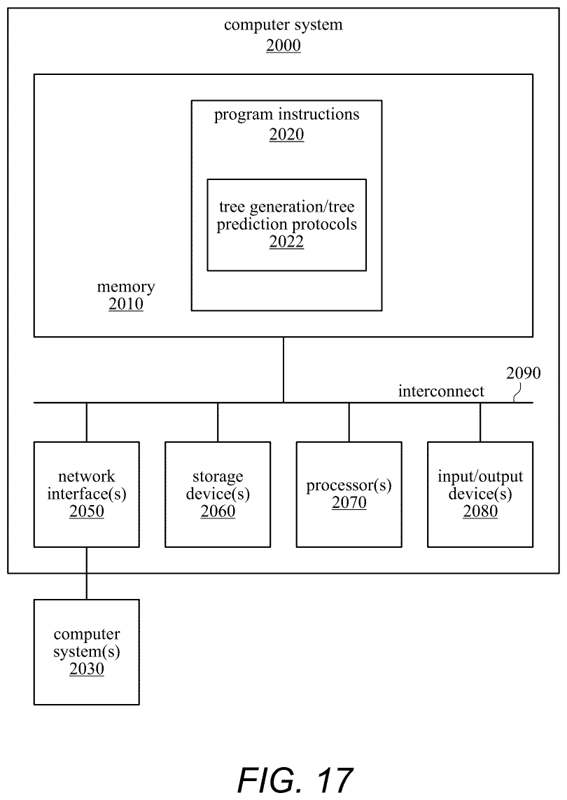

Various different systems, services, or applications may implement the techniques discussed above. FIG. 17 is a block diagram illustrating one embodiment of a computing system that is configured to implement privacy-preserving decision trees using secure multiparty computation and differential privacy, according to some embodiments.

The computer system 2000 may be any of various types of devices, including, but not limited to, a personal computer system, desktop computer, laptop or notebook computer, mainframe computer system, handheld computer, workstation, network computer, a consumer device, application server, storage device, a peripheral device such as a switch, modem, router, etc., or in general any type of computing device.

The mechanisms for implementing subject level privacy attack analysis for federated learning, as described herein, may be provided as a computer program product, or software, that may include a non-transitory, computer-readable storage medium having stored thereon instructions, which may be used to program a computer system (or other electronic devices) to perform a process according to various embodiments. A non-

transitory, computer-readable storage medium may include any mechanism for storing information in a form (e.g., software, processing application) readable by a machine (e.g., a computer). The machine-readable storage medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; electrical, or other types of medium suitable for storing program instructions. In addition, program instructions may be communicated using optical, acoustical or other form of propagated signal (e.g., carrier waves, infrared signals, digital signals, etc.)

In various embodiments, computer system 2000 may include one or more processors 2070; each may include multiple cores, any of which may be single or multi-threaded. Each of the processors 2070 may include a hierarchy of caches, in various embodiments. The computer system 2000 may also include one or more persistent storage devices 2060 (e.g. optical storage, magnetic storage, hard drive, tape drive, solid state memory, etc.) and one or more system memories 2010 (e.g., one or more of cache, SRAM, DRAM, RDRAM, EDO RAM, DDR RAM, SDRAM, Rambus RAM, EEPROM, etc.).

Various embodiments may include fewer or additional components not illustrated in FIG. 17 (e.g., video cards, audio cards, additional network interfaces, peripheral devices, a network interface such as an ATM interface, an Ethernet interface, a Frame Relay interface, etc.)

The one or more processors 2070, the storage device(s) 2050, and the system memory 2010 may be coupled to the system interconnect 2040. One or more of the system memories 2010 may contain program instructions 2020. Program instructions 2020 may be executable to implement various features described above, including a tree generation and tree prediction protocols and other techniques 2022 as discussed above with regard to FIGS. 1-7, in some embodiments as described herein. Program instructions 2020 may be encoded in platform native binary, any interpreted language such as Java™ byte-code, or in any other language such as C/C++, Java™, etc. or in any combination thereof. System memories 2010 may also contain LRU queue(s) 2026 upon which concurrent remove and add-to-front operations may be performed, in some embodiments.

In one embodiment, Interconnect 2090 may be configured to coordinate I/O traffic between processors 2070, storage devices 2070, and any peripheral devices in the device, including network interfaces 2050 or other peripheral interfaces, such as input/output devices 2080. In some embodiments, Interconnect 2090 may perform any necessary protocol, timing or other data transformations to convert data signals from one component (e.g., system memory 2010) into a format suitable for use by another component (e.g., processor 2070). In some embodiments, Interconnect 2090 may include support for devices attached through various types of peripheral buses, such as a variant of the Peripheral Component Interconnect (PCI) bus standard or the Universal Serial Bus

(USB) standard, for example. In some embodiments, the function of Interconnect 2090 may be split into two or more separate components, such as a north bridge and a south bridge, for example. In addition, in some embodiments some or all of the functionality of Interconnect 2090, such as an interface to system memory 2010, may be incorporated directly into processor 2070.

Network interface 2050 may be configured to allow data to be exchanged between computer system 2000 and other devices attached to a network, such as other computer systems, or between nodes of computer system 2000. In various embodiments, network interface 2050 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 2080 may, in some embodiments, include one or more display terminals, keyboards, keypads, touchpads, scanning devices, voice or optical recognition devices, or any other devices suitable for entering or retrieving data by one or more computer system 2000. Multiple input/output devices 2080 may be present in computer system 2000 or may be distributed on various nodes of computer system 2000. In some embodiments, similar input/output devices may be separate from computer system 2000 and may interact with one or more nodes of computer system 2000 through a wired or wireless connection, such as over network interface 2050.

Those skilled in the art will appreciate that computer system 2000 is merely illustrative and is not intended to limit the scope of the methods for providing enhanced accountability and trust in distributed ledgers as described herein. In particular, the computer system and devices may include any combination of hardware or software that may perform the indicated functions, including computers, network devices, internet appliances, PDAs, wireless phones, pagers, etc. Computer system 2000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 2000 may be transmitted to computer system 800 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed:

1. A system, comprising:
one or more processing nodes individually comprising at least one processor and a memory, the memory comprising program instructions that when executed by the at least one processor cause the at least one processor to implement a model generation protocol configured to recursively generate a sub-tree of a differentially-private decision tree, wherein to recursively generate the sub-tree the model generation protocol is configured to:
determine, from a data set previously partitioned according to a parent sub-tree, a plurality of class partitions individually comprising respective differentially-private frequencies for a plurality of attributes of the data set;
generate respective quality scores for the plurality attributes based at least in part on the plurality of class partitions;
select an attribute of the respective attributes according to the respective quality scores; and
partition, to build a plurality of child sub-trees, the data set according to an encoding determined for the selected attribute; wherein to build individual ones of the plurality of child sub-trees the model generation protocol is configured to recurse according to the partitioned data set.

2. The system of claim 1, wherein the model generation protocol is further configured to generate a leaf node, wherein to generate the leaf node the model generation protocol is configured to:
determine, from another data set previously partitioned according to another parent sub-tree, another plurality of class partitions individually comprising respective other differentially-private frequencies for the plurality of attributes of the data set;
create the leaf node based at least in part on a maximum differentially-private frequency of the respective other differentially-private frequencies.

3. The system of claim 1, wherein the differentially-private decision tree comprises a plurality of decision nodes and a plurality of leaf nodes, and wherein individual ones of the plurality of decision nodes have a same number of child nodes.

4. The system of claim 1, wherein to determine the plurality of differentially-private frequencies the model generation protocol is configured to add respective amounts of noise to individual ones of respective determined differentially-private frequencies according to respective provided privacy and sensitivity parameters.

5. The system of claim 1, wherein the one or more processing nodes comprise a plurality of processing nodes collectively implementing a secure multiparty computation protocol.

6. The system of claim 1, wherein to generate a quality score of the respective quality scores for the plurality attributes the model generation protocol is configured to sum respective maximum one-hot encoding frequencies of the plurality of class partitions for individual ones of the one-hot encoding frequencies.

7. The system of claim 1, wherein to select the attribute of the respective attributes the model generation protocol is configured to select an attribute of a portion of available attributes of the plurality of attributes of the data set having a highest quality score of the respective quality scores.

8. A computer-implemented method, comprising:
performing, by one or more processing nodes, a model generation protocol to generate a sub-tree of a differentially-private decision tree, comprising:
determining, from a data set previously partitioned according to a parent sub-tree, a plurality of class partitions individually comprising respective differentially-private frequencies for a plurality of attributes of the data set;
generating respective quality scores for the plurality attributes based at least in part on the plurality of class partitions;
selecting an attribute of the respective attributes according to the respective quality scores; and
partitioning, to build a plurality of child sub-trees, the data set according to an encoding determined for the selected attribute; wherein to build individual ones of the plurality of child sub-trees the model generation protocol is configured to recurse according to the partitioned data set.

9. The computer-implemented method of claim 8, further comprising generating a leaf node, comprising:
determining, from another data set previously partitioned according to another parent sub-tree, another plurality of class partitions individually comprising respective other differentially-private frequencies for the plurality of attributes of the data set;
creating the leaf node based at least in part on a maximum differentially-private frequency of the respective other differentially-private frequencies.

10. The computer-implemented method of claim 8, wherein the differentially-private decision tree comprises a plurality of decision nodes and a plurality of leaf nodes, and wherein individual ones of the plurality of decision nodes have a same number of child nodes.

11. The computer-implemented method of claim 8, wherein determining the plurality of differentially-private frequencies comprises adding respective amounts of noise to individual ones of respective determined differentially-private frequencies according to respective provided privacy and sensitivity parameters.

12. The computer-implemented method of claim 8, wherein the one or more processing nodes comprise a plurality of processing nodes collectively implementing a secure multiparty computation protocol.

13. The computer-implemented method of claim 8, wherein generating a quality score of the respective quality scores for the plurality attributes comprises summing respective maximum one-hot encoding frequencies of the plurality of class partitions for individual ones of the one-hot encoding frequencies.

14. The computer-implemented method of claim 8, wherein selecting the attribute of the respective attributes comprises selecting an attribute of a portion of available attributes of the plurality of attributes of the data set having a highest quality score of the respective quality scores.

15. One or more non-transitory, computer-readable storage media, storing program instructions that when executed on or across one or more computing devices, cause the one or more computing devices to implement a model generation protocol to perform generating a sub-tree of a differentially-private decision tree, comprising:
determining, from a data set previously partitioned according to a parent sub-tree, a plurality of class partitions individually comprising respective differentially-private frequencies for a plurality of attributes of the data set;
generating respective quality scores for the plurality attributes based at least in part on the plurality of class partitions;
selecting an attribute of the respective attributes according to the respective quality scores; and
partitioning, to build a plurality of child sub-trees, the data set according to an encoding determined for the selected attribute; wherein to build individual ones of the plurality of child sub-trees the model generation protocol is configured to recurse according to the partitioned data set.

16. The one or more non-transitory, computer-readable storage media of claim 15, wherein generating the sub-tree of a differentially-private decision tree further comprises:
determining, from another data set previously partitioned according to another parent sub-tree, another plurality of class partitions individually comprising respective other differentially-private frequencies for the plurality of attributes of the data set;
creating the leaf node based at least in part on a maximum differentially-private frequency of the respective other differentially-private frequencies.

17. The one or more non-transitory, computer-readable storage media of claim 15, wherein the differentially-private decision tree comprises a plurality of decision nodes and a plurality of leaf nodes, and wherein individual ones of the plurality of decision nodes have a same number of child nodes.

18. The one or more non-transitory, computer-readable storage media of claim 15, wherein determining the plurality of differentially-private frequencies comprises adding respective amounts of noise to individual ones of respective determined differentially-private frequencies according to respective provided privacy and sensitivity parameters.

19. The one or more non-transitory, computer-readable storage media of claim 15, wherein the one or more processing nodes comprise a plurality of processing nodes collectively implementing a secure multiparty computation protocol.

20. The one or more non-transitory, computer-readable storage media of claim 15, wherein generating a quality score of the respective quality scores for the plurality attributes comprises summing respective maximum one-hot encoding frequencies of the plurality of class partitions for individual ones of the one-hot encoding frequencies.
